(19) United States
(12) Patent Application Publication
(10) Pub. No.: US 2018/0134590 A1
(43) Pub. Date: May 17, 2018

(54) SYSTEMS AND METHODS FOR REMOVING CHROMIUM FROM AQUEOUS MEDIA

(71) Applicant: Water Remediation Technology LLC, Arvada, CO (US)

(72) Inventor: James M. Arnold, Arvada, CO (US)

(21) Appl. No.: 15/812,415

(22) Filed: Nov. 14, 2017

Related U.S. Application Data
(60) Provisional application No. 62/421,778, filed on Nov. 14, 2016.

(51) Int. Cl. C02F 1/70; C02F 1/68; C02F 1/00

(52) U.S. Cl. CPC C02F 1/70; C02F 2101/22; C02F 1/004; C02F 1/686

(57) ABSTRACT

Systems and methods for removing chromium from aqueous media, such as from drinking water, are described. Hexavalent chromium is reduced to trivalent chromium, which is captured in filter media and may be collected.

### CROSS REFERENCE TO RELATED APPLICATIONS

This patent application claims the benefit of priority of U.S. Patent Application No. 62/421,778, filed Nov. 14, 2016 and entitled “Systems and methods for removing chromium from aqueous media,” which is hereby incorporated by reference.

### TECHNICAL FIELD

The present disclosure relates to systems and methods for removing chromium, including hexavalent chromium, from aqueous media.

### BACKGROUND

Hexavalent chromium—Cr(VI), chromium-6, one of the valence states (+6) of elemental chromium—occurs naturally in the environment and can also be produced by industrial processes. Hexavalent chromium compounds are used in alloy steel to increase hardenability and corrosion resistance; as pigments in dyes, paints, inks, and plastics; and as anticorrosive agent in paints, primers, and other surface coatings. Exposure to hexavalent chromium by inhalation or ingestion may cause cancer, skin irritation and ulceration, erosion and discoloration of the teeth, eye irritation and damage, respiratory tract irritation and ulceration, pulmonary congestion and edema, kidney damage, and liver damage. In contrast, trivalent chromium—Cr(III), chromium-3, another valence state (+3) of elemental chromium—is an essential human dietary element.

The United States Environmental Protection Agency has established a maximum contaminant level (MCL) in drinking water of 0.1 milligrams per liter (mg/L) or 100 parts per billion (ppb) for total chromium. This level includes all forms of chromium, including hexavalent chromium. In 2014, the state of California established an MCL specifically for hexavalent chromium, set at 10 ppb. Currently, hexavalent chromium is not specifically regulated. However, the state of California has established an MCL of 50 ppb for total chromium.

Municipalities have worked to comply with chromium MCL standards in their drinking water supplies by removing, containing, or reducing the toxicity of chromium. Removal methods have included ion-exchange resins from which the chromium must be recovered and the spent resins must be recharged, which are costly processes. Removal methods in general produce a chromium-contaminated waste volume, usually a sludge, that must be disposed of properly. Waste disposal is also a costly process and creates transportation and storage safety concerns.

### SUMMARY

The present disclosure provides systems and methods for removing chromium, including hexavalent chromium, from aqueous media. The systems and methods can be used to remove chromium from a drinking water source in compliance with national, state, or local regulations.

The systems may include a reducing agent, a reactor media, and a solids filtration unit. The reducing agent may be a transition metal based reducing agent. In some embodiments, the reducing agent is a ferrous reducing agent. One example of a ferrous reducing agent is ferrous sulfate.

The reactor media may comprise a zeolite. In some embodiments, the zeolite is clinoptilolite. In some embodiments, the zeolite is a transition metal-loaded zeolite. Iron is one example of a transition metal that may be included in a transition metal-loaded zeolite. The reactor media may be provided in a vessel, such as a column.

The solids filtration unit may include one or more types of media. In some embodiments, the filtration unit includes sand. The unit may be a horizontally oriented cylinder or a vertically oriented column.

Methods of removing chromium from an aqueous medium are also disclosed herein. Methods may include providing a raw aqueous medium and a reducing agent; contacting the raw aqueous medium with a reactor media; reducing hexavalent chromium in the aqueous medium; oxidizing the reducing agent; capturing the reduced chromium and the oxidized reducing agent; and releasing a treated aqueous medium having a reduced level of chromium. In the methods, hexavalent chromium may be reduced to trivalent chromium.

In some embodiments, reducing hexavalent chromium and oxidizing the reducing agent occur in or on the reactor media. The reduced chromium and the oxidized reducing agent may be insoluble and may precipitate or co-precipitate. The reduced chromium and the oxidized reducing agent may pass through the reactor media. In some embodiments, the methods include a step of adsorbing the reduced chromium on the oxidized reducing agent.

In some embodiments, the aqueous media treated by the disclosed methods has 100 ppb or less of total chromium. In some embodiments, the aqueous media treated by the disclosed methods has 10 ppb or less of hexavalent chromium.

In some embodiments, the methods include a step of releasing and collecting the captured reduced chromium and oxidized reducing agent. The reduced chromium may be released by backwashing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments of the invention and illustrated in the accompanying drawings.

### BRIEF DESCRIPTION OF THE DRAWINGS

FIG. 1 is a schematic illustrating a chromium removal system according to one embodiment.

FIG. 2 is a flow diagram of a chromium removal system according to one embodiment.

FIG. 3 is a flow diagram of a chromium removal method according to one embodiment.

### DETAILED DESCRIPTION

### Definitions

The following definitions are provided to facilitate understanding of certain terms used frequently herein and are not meant to limit the scope of the present disclosure.

“Aqueous medium” refers to water or any liquid made from, with, or by water. Included in “aqueous medium” is water for consumption and/or personal use, i.e. “potable water”, as well as water not intended for consumption treatable for removal of chromium, e.g. waste water streams. “Aqueous medium” includes drinking water and water that if treated would be suitable for drinking, particularly by humans but also by animals. “Aqueous medium” also includes wastewater, such as that which results from industrial or agricultural processes.

“Raw” aqueous medium refers to an aqueous medium before being processed by the systems or methods disclosed herein. This can also be referred to as “untreated” aqueous medium.

“Treated” aqueous medium accordingly refers to an aqueous medium processed by the systems or methods disclosed herein.

“Chromium” as used herein refers to the element by the same name; ions by the same name; chromate ions; dichromate ions; and compounds, including salts, comprising chromium or chromate, where the element, ions, and compounds may be in any charge state and any oxidized or reduced form.

“Remove” refers to the detectable decrease in the amount of a substance, such as chromium, from a source, such as an aqueous medium or a filter.

“Zeolite” as used herein can be natural or synthetic and may be stabilized. Natural zeolites are hydrated silicates of aluminum and sodium, calcium, or both sodium and calcium. Examples of natural zeolites include clinoptilolite and chabazite. Natural zeolites are generally disclosed in, for example, the subcommittee on zeolites of the International Mineralogical Association, Commission on New Minerals and Mineral Names and Armbruster et al., 2001. Stabilized zeolites have been treated to reduce the amount of intrinsic substances that leach into the aqueous medium.

A “transition metal-loaded zeolite” is one which has been treated with a transition metal. A transition metal-loaded zeolite is an example of a stabilized zeolite.

“Absorb” and “adsorb” refer to the principle of one substance being retained by another substance. Encompassed absorption and adsorption processes can include attraction of one substance to the surface of another substance or the penetration of one substance into the inner structure of another substance. As disclosed herein, an oxidized reducing agent may absorb and/or adsorb reduced chromium from an aqueous medium. For purposes of the present disclosure, the two terms are used interchangeably. Other terms used to describe these interactions include associating, attaching, binding, or complexing, each of which contemplate absorption and/or adsorption.

### Chromium Removal Systems

Disclosed herein is a hexavalent chromium removal system using select reducing agent addition, a high efficiency media contactor and a media filtration system. Hexavalent chromium is safely reduced to trivalent chrome and adsorbed within a formed solid adsorbant to be collected on the downstream media filter. The solid adsorbant is removed from the media filter with a backwash cycle for collection of solids and final settling, solids dewatering and preparation for disposal. Disposal material volumes are small, amounting to less than 40 grams per 1,000 gallons treated. The system is designed for water to move through the treatment equipment using the water pressure generated from the well source. In some embodiments, the water treatment chemical added to the water for the treatment process and the proprietary contactor media were NSF/ANSI-44/60 and NSF/ANSI-44/61 certified for use in drinking water systems. The contactor media is not regenerated and will have nearly unlimited service life. Hexavalent chrome removal is enabled by the consistent water treatment reagent chemical addition rate and effective adsorbant filtration and removal.

Systems for removing chromium from an aqueous medium are disclosed herein. The aqueous medium may be water, such as from a municipal drinking water supply. The system may include a reducing agent, a reactor media, and a solids filtration unit. The reducing agent may be any chemical species capable of donating one or more electrons to another chemical species in an oxidation-reduction reaction. In some examples, the reducing agent may be a transition metal-based reducing agent. The reducing agent may be aluminum chloride, ferrous chloride, ferrous sulfate (iron(II) sulfate), hydrazine, magnesium tetrahydoaluminate, sodium bisulfite, stannous chloride, or zinc metal. In some examples, the reducing agent is provided as a liquid, such as in a solution. The reducing agent may be provided at 0.1 to 1.5 mg/L of aqueous media to be treated, 0.2 to 1.5 mg/L, 0.3 to 1.5 mg/L, 0.4 to 1.5 mg/L, 0.5 to 1.5 mg/L, 0.75 to 1.5 mg/L, 1 to 1.5 mg/L, 0.1 to 1.4 mg/L, 0.1 to 1.3 mg/L, 0.1 to 1.2 mg/L, 0.1 to 1.1 mg/L, 0.1 to 1.0 mg/L, 0.1 to 0.75 mg/L, or 0.25 to 1.0 mg/L of aqueous media to be treated. In one example, the reducing agent may be provided at about 0.75 mg/L of aqueous media to be treated. In another example, the reducing agent may be provided at about 0.6 mg/L of aqueous media to be treated. In another example, the reducing agent may be provided at about 0.25 to 1.0 mg/L of aqueous media to be treated.

The reactor medium may be any composition that promotes or is conducive to redox reactions. The medium may provide a high surface area to volume ratio on which such reactions can occur. The medium may include or be configured to receive oxidizing or reducing agents that are involved in the redox reactions. In some examples, the reactor media supports but is not depleted by redox reactions such that it can continuously support redox reactions without the need to be recharged or regenerated. In some examples, the reactor media has an unlimited or nearly unlimited service life.

In some examples, the reactor media is a natural or synthetic zeolite or a combination of natural and synthetic zeolites. Natural zeolites are hydrated silicates of aluminum and sodium, calcium, or both sodium and calcium. Zeolites have a rigid three-dimensional crystalline structure. The rigid honeycomb-like crystalline structure includes a network of interconnected tunnels and cages that form a series of substantially uniformly sized pores. Aqueous media moves freely in and out of the pores, which makes zeolites well-suited for sieving or filtration functions. The crystalline structure also provides a high surface area to volume ratio for binding target contaminants such as chromium. Natural zeolites can both store and release water molecules and positively charged ions such as those of potassium, sodium, calcium, and transition metals.

Natural zeolites include clinoptilolite, chabazite, phillipsite, mordenite, analcite, heulandite, stilbite, thomosonite, brewsterite, wellsite, harmotome, leonhardite, eschellite, erionite, epidesmine, and the like. Zeolites are characterized by particle density, cation selectivity, molecular pore size, and cation affinity. For example, clinoptilolite, the most common natural zeolite, has 16% more void volume and pore size up to 0.2 nm larger than analcime, another common zeolite. In some examples, the reactor media is clinoptilolite.

Synthetic zeolites are made by processes known in the art, such as a gel process (sodium silicate and alumina) or clay process (kaolin), which form a matrix to which the zeolite is added. Examples of synthetic zeolites include Linde® AW-30, Linde® AW-500, Linde®4-A, and Zeolon®900.

In some examples, the reactor media is a natural zeolite capable of loading a transition metal. A transition metal-loaded zeolite may be one as described in U.S. Pat. No. 8,663,479, which is incorporated by reference in its entirety herein. Briefly, the concentration of transition metal in a natural zeolite is between about 0.01 meq to about 1.5 meq and often about 1 to about 2 meq. Natural zeolites described in U.S. Pat. No. 8,663,479 are treated with an amount of transition metal sufficient to stabilize arsenic on the zeolite and limit or prevent leaching of the arsenic from the natural zeolite during contact with an aqueous medium. The described natural zeolites may be underloaded with transition metal, having about 0.01 to about 0.5 meq of transition metal. In some examples, the natural zeolite is loaded with iron(II), iron(III), or titanium (III). In some examples, the reactor media is a ferrous-loaded zeolite.

Transition metal-loaded zeolites, including underloaded zeolites, may be produced by the process described in U.S. Pat. No. 8,663,479. As an example, a ferrous (Fe(II)) loaded zeolite may be prepared by combining ferrous ions with a natural zeolite in a column at a pH less than 6.0. A low and controlled pH can help to minimize precipitation of the various iron-containing materials within the pores of the zeolite. The ferrous-loaded zeolite is then slowly rinsed and neutralized to remove the unbound ions and to raise the pH of the column to approximately 4.0 to 5.5. The treated zeolite is then drained, dewatered, and rinsed multiple times with DI water. The rinsed natural zeolite is then low-temperature dried. The method may help keep more of the surface area of the zeolite material open for absorption.

In some examples described herein, the reactor media is provided in a container, which may be a column or other similar vessel. The amount of reactor media in the container may vary depending on factors such as the size of the container and the volume of aqueous media passing through the container. The volume of reactor media as a percentage of the volume of the reactor media container may be about 40 to about 80 percent, about 50 to about 80 percent, about 60 to about 80 percent, about 70 to about 80 percent, about 40 to about 70 percent, about 40 to about 60 percent, or about 40 to about 50 percent. In one example, the reactor media fills about 60 percent of the volume of the container in which it is held.

The solids filtration unit in the system for removing chromium is capable of both storing and releasing particulate solids that have passed through the reactor medium. The filtration unit may include a plurality of types of media. The media types may have different compositions and/or particle sizes. Examples of media types include graded silica sand, garnet, quartz, pyrolusite, diatomaceous earth, zeolite, manganese greensand, graded gravel, and anthracite-based media. The media particles may have a nominal diameter of from 100 to 7000 μm, 100 to 6500 μm, 100 to 6000 μm, 100 to 5000 μm, 100 to 4000 μm, 100 to 3000 μm, 100 to 2000 μm, 125 to 7000 μm, 150 to 7000 μm, 200 to 7000 μm, 300 to 7000 μm, 400 to 7000 μm, 500 to 7000 μm, 750 to 7000 μm, 1000 to 7000 μm, or 150 to 6000 μm. In one example, the media particles have a nominal diameter of 150 μm to 6000 μm.

In some examples, the solids filtration unit is a column, such as a vertically oriented column, or a horizontally oriented cylinder, or other similar vessel. The amount of media in the vessel may vary depending on factors such as the size of the vessel, the volume of aqueous media passing through the vessel, and the amount of matter to be filtered out of the aqueous media by the solids filtration unit. The volume of media as a percentage of the volume of the solids filtration unit may be about 30 to about 70 percent, about 40 to about 70 percent, about 50 to about 70 percent, about 60 to about 70 percent, about 30 to about 60 percent, about 30 to about 50 percent, or about 30 to about 40 percent. In one example, the media fills about 50 percent of the volume of the vessel in which it is held.

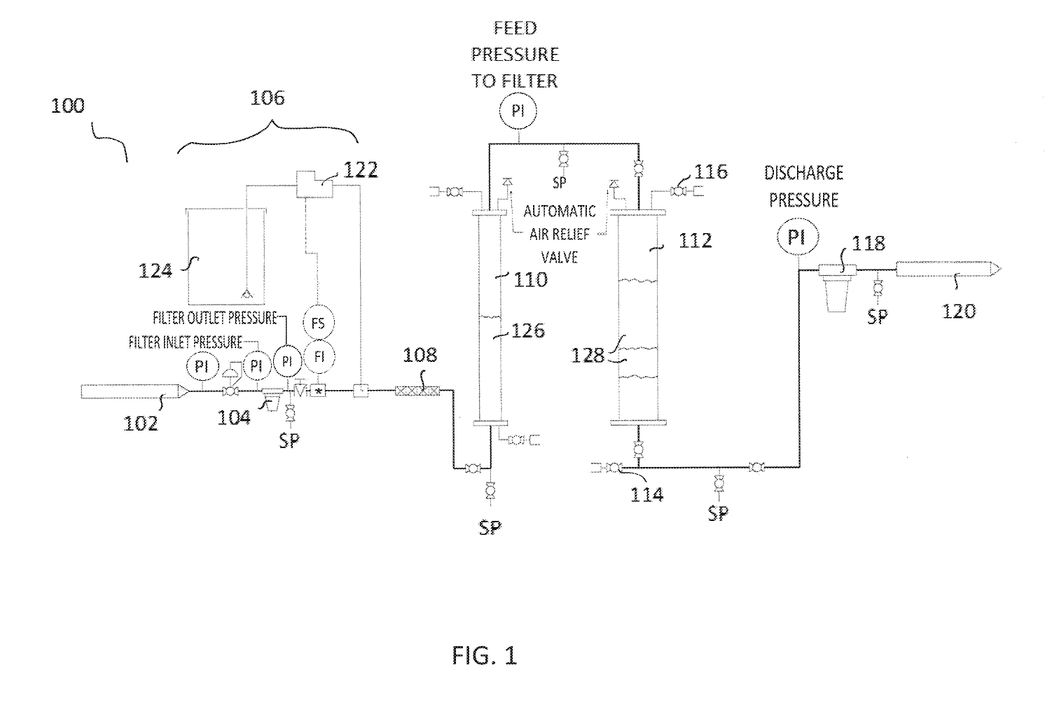

FIG. 1, and Example 1 as described in more detail below, illustrates another example of a chromium removal system. The chromium removal system 100 may include a raw (untreated) water inlet 102, a reducing agent injector system 106, an in-line mixer 108, a reactor column 110, a solids filtration unit 112, a backflow inlet 114, a backflow outlet 116, and a treated water outlet 120. The reducing agent injector system 106 may include a reagent metering pump 122 to meter the addition of a reducing agent solution 124. The reactor column 110 may contain reactor media 126. The solids filtration unit 112 may include variably sized filter media 128. The chromium removal system 100 may also include one or both of a pre-filter 104 and a cartridge filter unit 118.

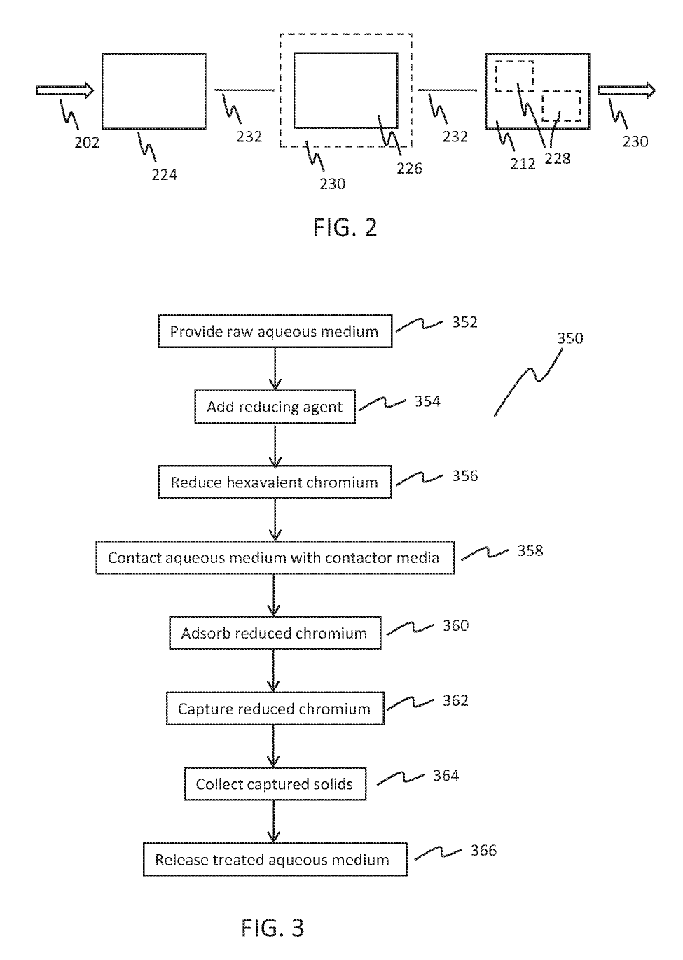

With reference to FIG. 2, a chromium removal system 200 includes a reducing agent 224, a reactor medium 226, and a solids filtration unit 212. The reactor medium 226 may be provided in an optional vessel 230. The solids filtration unit 212 includes a plurality of filter media 228. The system 200 optionally includes an inlet 202 for a raw aqueous media and an outlet 220 for treated aqueous media. One or more fluid connections 232 may connect components of the system 200.

### Chromium Removal Methods

Methods for removing chromium from an aqueous medium are disclosed herein. The methods may be performed as batch or continuous methods. The aqueous medium may be water, such as from a municipal drinking water supply. The method may include reducing hexavalent chromium and capturing the reduced chromium. Hexavalent chromium is reduced to a lower valence state, such as to trivalent chromium, by a reducing agent. The reducing agent may be any reducing agent described above, such as a transition metal reducing agent, which may be a ferrous reducing agent. In some examples, the reducing agent is added to the aqueous media. In some examples, the reducing agent is provided in or on a reactor media. The reactor media may be any reactor media described above, such as transition metal-loaded zeolite. The reactor media may also be referred to as a contactor media in this application. In some examples, the reduction reactions occur in the aqueous media. In some examples, the reduction reactions occur in or on the reactor media. The reduction reactions may happen quickly, such as in a few seconds up to a minute. The reduction reactions can proceed without depletion of the reduction capacity of the reactor media. In these examples, reduction reactions can continue indefinitely without recharging or regenerating the reactor media.

The reduced chromium is insoluble and precipitates out of the aqueous media. It can then be captured, such as by filtration. In some examples, the chromium flows to and is captured by a filtration device, which may be a solids filtration unit described above. The chromium may be captured in any one or more of the media types in the solids filtration unit.

In some examples, methods for removing chromium from an aqueous medium may also include adsorption of chromium from the aqueous medium prior to capturing the chromium. In one example of such methods, the reducing agent that reduces hexavalent chromium is itself oxidized to an insoluble form. The insoluble oxidized reducing agent co-precipitates with the insoluble reduced chromium and the chromium is physically associated with the oxidized reducing agent, such as by adsorption. The reducing agent may be a ferrous reducing agent and the ferrous reducing agent may oxidize to an insoluble ferric compound that may associate with the reduced chromium. If the reducing agent was in or on the reactor media, oxidation of the reducing agent may help release it from the reactor media. In these examples, the co-precipitated oxidized reducing agent may also be captured as described above for the reduced chromium, such as by filtration.

In some examples of methods described herein, the captured solids, which may include reduced chromium and/or oxidized reducing agent, may be partially or completely removed from the filtration device. The removal may be by any technique for removing suspended solids such as backwashing, microfiltration, and membrane ultrafiltration.

As one example, and as further described in Example 2, backwashing is accomplished by directing raw aqueous media upflow through the filtration device. The filtration device may first be isolated from other system components. The upflow may expand the media bed and release the captured solids. The volume of backwash may be adjusted to expand the filter media to a desired amount. For example, the volume of backwash may expand the filter media bed from about 10 percent to about 70 percent, from about 10 percent to about 60 percent, from about 10 percent to about 50 percent, from about 10 percent to about 40 percent, from about 10 percent to about 30 percent, from about 20 percent to about 70 percent, from about 30 percent to about 70 percent, from about 40 percent to about 70 percent, or from about 50 percent to about 70 percent. In one example, the backwash expands the filter media by about 40 percent.

The upflow may be discharged at the front or beginning of the filtration device. The backwash liquid and released solids may be collected for further concentration, solids separation, testing, and/or proper disposal. After some or all of the captured solids have been release from the filtration device, the device can be reused.

With reference to FIG. 3, a method 350 of removing chromium from an aqueous medium includes a step 356 of reducing hexavalent chromium and a step 362 of capturing the reduced chromium. The method 350 optionally includes a step 352 of providing a raw aqueous media and optionally includes a step 354 of adding a reducing agent to the raw aqueous media. The reducing agent reduces hexavalent chromium, such as to trivalent chromium, in step 356. Step 356 may include one or more of precipitation of insoluble reduced chromium, oxidation of the reducing agent, and precipitation of the insoluble oxidized reducing agent. A step 358 of contacting the aqueous media with reactor media is optionally included and, if present, may occur before, after, or contemporaneously with step 356. A step 360 of adsorbing the reduced chromium, such as by the oxidized reducing agent, may be included.

Step 362 of capturing the reduced chromium may also include capturing the oxidized reducing agent. When step 360 is included, step 362 includes capturing reduced chromium adsorbed to the oxidized reducing agent. The method 350 optionally includes a step 364 of collecting the solids captured in step 362. When step 360 is present, step 364 includes collection of both reduced chromium and oxidized reducing agent. Step 364 may be a backwashing process. The method 350 optionally includes a step 366 of releasing aqueous water treated by the method 350 of some or all of steps 352-364. Steps 364 and 366 are temporally interchangeable.

In the operation of the described methods, a treated aqueous medium may be produced that is in compliance with an MCL of 100 ppb for total chromium. In some examples, the treated aqueous medium has less than 100 ppb for total chromium. In some examples, the treated medium is in compliance with an MCL of 10 ppb for hexavalent chromium, as set by the state of California. In some examples, the treated aqueous medium has less than 10 ppb for hexavalent chromium.

In the operation of the described methods, less hazardous waste is produced compared to existing chromium removal methods. Each of the mass of waste solids and the volume of waste liquids may be reduced. Waste liquids can be processed repeatedly by the disclosed methods such that little or no liquid waste requires disposal. The reduction in the amount of waste treatment residuals may reduce the operating costs compared to other chromium removal methods. The reduction may also be more environmentally favorable.

Association with Other Water Treatment Systems and Methods

The chromium removal systems and methods described herein may be capable of incorporation into conventional water treatment systems, which may be as stand-alone units. The incorporation of the present systems and methods may not require that the existing system or method be re-designed, but rather, that the chromium removal systems and methods be adapted to function before, during, or after the conventional water treatment.

The chromium removal systems and methods may be added to existing aqueous media treatment facilities as a “turn-key” or “bolt-on” system or method. The treatment facilities can be used to improve the quality of aqueous media in a number of applications, including drinking water, waste water, agricultural water, and ground water. Similarly, the chromium removal systems and methods may be incorporated into new aqueous media treatment facilities, again as “turn-key” or “bolt-on” systems or methods, or integrated into a treatment facility as designed by one of skill in the art. The chromium removal systems and methods, when used in conjunction with other water treatment systems or methods, produces a treated aqueous media having total chromium levels of 100 ppb or less and hexavalent chromium levels of 10 ppb or less, as required by federal and state guidelines.

### EXAMPLES

The following Examples illustrate various aspects of the present disclosure. It will be apparent to those skilled in the art that many modifications, both to materials and methods, may be practiced without departing from the scope of the disclosure.

### Example 1: Chromium Removal System

A 0.90 gallons per minute (gpm) pilot-scale system was installed at a groundwater well in California. Prior to installation, the hexavalent chromium concentration of water produced from the well was 11-12 μg/L, which is higher than the MCL of 10 μg/L in California.

With reference to FIG. 1, the chromium removal system 100 included a raw (untreated) water inlet 102, a pre-filter 104, a reducing agent injector system 106, an in-line mixer 108, a reactor column 110, a solids filtration unit 112, a backflow inlet 114, a backflow outlet 116, a cartridge filter unit 118, and a treated water outlet 120. The reducing agent injector system 106 included a reagent metering pump 122 to meter the addition of a reducing agent solution 124. The reactor column 110 measured 4 inches in diameter and 40 inches in vertical height. It contained approximately 24 inches (4,500 grams) of clinoptilolite zeolite media 126. The solids filtration unit 112 measured 6 inches in diameter and 40 inches in vertical height and contained approximately 20 inches of variably sized filter media 128. The cartridge filter unit 118 was used to assess the effectiveness of the solids filtration unit 112.

### Example 2: Chromium Removal Method

The chromium removal system 100 of Example 1 was used to remove chromium from groundwater sourced from a well according to the following method.

Raw water exited a connection on the main well discharge piping and traveled through a flexible hose, a pressure reducing valve, and a flow meter totalizer. The flow moved through the system 100 equipment using the water pressure generated from the well.

The raw water entered the system 100 at the water inlet 102 and passed through the pre-filter 104. The reducing agent solution 124 (20% ferrous sulfate solution) was added at a rate of 0.75 mg/L to the water via the reducing agent injector system 106 and the solution 124 was then mixed with the in-line mixer 108. The flow then entered the bottom of the reactor column 110 and flowed up through the clinoptilolite zeolite media 126. The flow exited the top of the column 110 and was directed through flexible tubing to the downflow solids filtration unit 112 where it passed through filter media 128. As mentioned above, where the system 100 includes a cartridge filter unit 118, then before exiting the system 100 at the treated water outlet 120, the flow is passed through the cartridge filter unit 118.

The solids filtration unit 112 was backwashed initially once every two weeks and then once every week. Backwashing was performed manually by isolating the solids filtration unit 112, connecting a fresh raw water source to the backflow inlet 114 at the bottom of the unit, and opening the backflow outlet 116 at the top of the unit. Raw water was directed upflow from the backflow inlet 114, through the solids filtration unit 112, and through the backflow outlet 116 at the top of the unit 112. Backwash flow regulation was set manually and was adjusted to provide approximately 40 percent expansion of the filter media 128 bed, from which the collected solids were released. The backwashed liquid and solids were collected for testing.

The test well operated for 12 to 22 hours per day and the system 100 was equipped with an automated flow-sensing switch to interrupt addition of the reducing agent solution 124 during the 2- to 12-hour standby period. When flow was restored following a standby period, injection of the reducing agent solution 124 recommenced and operation of the system 100 continued. Automatic vent relief valves in the system 100 assured that any accumulated air was purged from the vessels and piping. Operation of the system equipment was automatic but an operator occasionally manually adjusted flow rates, took samples, and gathered data.

### Example 3: Removal of Chromium from Water

While the method of Example 2 was being performed, water samples were collected in the system 100 upstream of the addition of the reducing agent solution 124 (“raw water” samples) and at the treated water outlet 120 (“treated water” samples). Samples were analyzed using EPA Method 200.7 for determining levels of total chromium (Cr(III)+Cr(VI)) in water and EPA Method 218.6 for determining levels of hexavalent chromium in water.

Data are presented in Table 1. Levels of both hexavalent chromium and total chromium were non-detectable in almost all samples when the system was fully operational. The presence of chromium in the treated samples when the reducing agent was not added (see Sample Date 06/01) suggests that the reducing agent solution plays a role in the effective reduction of hexavalent chromium to trivalent chromium and the removal of total chromium from the water.

The data demonstrate that the system of Example 1 and the method of Example 2 were highly effective at reducing all hexavalent chromium to trivalent chromium. The data also demonstrate that the system was highly effective at removing total chromium from the water.

TABLE 1

| | Cumulative | Raw Water | | Treated Water | |
|---|---|---|---|---|---|
| Sample Day of | Water | Cr (total) | Cr (6+) | Cr (total) | Cr (6+) |
| month | Treated (gal) | μg/L | μg/L | μg/L | μg/L |
| Month 1, day | 25,215 | 12 | 12 | ND | ND |
| 02 | | | | | |
| 04 | 27,135 | 12 | | ND | ND |
| 09 | 31,583 | 12 | | ND | ND |
| 11 | 33,076 | 12 | 11 | ND | ND |
| 16 | 36,922 | 12 | 10 | ND | ND |
| 18 | 38,927 | 12 | 11 | ND | ND |
| 23 | 42,924 | 11 | 12 | ND | ND |
| 25 | 44,485 | 11 | 12 | ND | ND |
| Month 2, day | — | 10 | 12 | 12 | 12 |
| 01* | | | | | |
| 06** | 55,581 | ND | ND | 11 | ND |
| 08 | 57,317 | 10 | 12 | ND | 1.0 |
| 15 | 64,426 | 11 | 12 | ND | ND |
| 20 | 68,592 | 11 | 12 | ND | ND |
| 22 | 70,443 | 11 | 12 | ND | ND |

*Sample taken when reagent chemical injection system was inoperable.
**Samples appear to have been mislabeled.

### Example 4: Filtration Efficiency

While the method of Example 2 was being performed, water samples were collected in the system 100 upstream of the addition of the reducing agent solution 124 (“raw water” samples) and at the treated water outlet 120 (“treated water” samples). Samples were analyzed using EPA Method 200.7 for determining total and dissolved iron levels.

Data are presented in Table 2. Iron levels were undetectable in the raw water samples and in several of the treated water samples. Iron was detected in treated water samples on some test dates, which suggests incomplete filtration of the water flow and pass-through of some iron-containing filterable solids. All detectable iron was in the fully oxidized ferric oxide form, suggesting that the ferrous sulfate reducing agent solution 124 was fully oxidized during the reduction of hexavalent chromium to trivalent chromium.

TABLE 2

| Sample Day of | Total Iron (μg/L Fe) | |
|---|---|---|
| Month | Raw Water | Treated Water Post Media Filter |
| Month 1, Day 18 | ND | 150 |
| 23 | ND | 460 |
| 25 | ND | ND |
| Month 2, day 01 | ND | ND |
| 06 | — | ND |
| 08 | — | 290 |
| 15 | — | ND |
| 20 | — | 430 |
| 22 | — | 230 |

### Example 5: Collected Solids

In the method of Example 2, approximately 10 gallons of backwash water volume was used to purge the solids filtration unit 112 of collected particulate solids until the backwash water ran essentially clear. Ten gallons corresponds to a 3.4 bed volume (BV) of total filter backwash water. The backwash water was analyzed for particle settling characterization and final solids testing.

Particle settling characterization was performed by methods known in the art. Particulate solids formed a fully settled mass in the bottom of a standard test settling cone in less than 4 hours. When samples were tested with a coagulant or flocculating aid, the solids did not settle appreciably faster than unaided settling, nor did they settle with improved clarity compared to unaided settling.

Total solids collected during a backwash reflect a 5-day long run period or approximately 4,100 gallons of treated water. The total weight of sludge solids collected from the 10-gallon backwash volume was 10.45 grams (dry weight). The total volume of settled sludge collected from the 10-gallon backwash volume was 293 milliliters. The low mass of solids and low volume of sludge were easy and inexpensive to dispose of Based on these waste amounts, approximately 70-80 liters of settled sludge and 2.5 kilograms of solids are produced for every 1 million gallons of water treated.

### Example 6: Optimization of System and Method

During performance of the method of Example 2, analysis of the solids filtration unit 112 revealed that filtered solids had deeply penetrated the media filter bed of the filtration unit 112. A large portion of the collected solids was deposited over the graded sand section of the filtration unit 112. The remaining filter media sections were less than 4 inches in depth, limiting the total solids holding capacity for the filtration unit 112 overall.

To improve filtration efficiency, the solids filtration unit 112 of the system of Example 1 was modified to include mostly filter sands. To help determine a minimum reducing agent flow rate, the reducing agent flow rate of the method of Example 2 was modified to 0.6 mg/L. Other components and steps remained unchanged.

Water samples were analyzed for total chromium and hexavalent chromium according to the method of Example 3. Data are presented in Table 3. Levels of both hexavalent chromium and total chromium were non-detectable in almost all samples.

The data demonstrate that decreasing the reducing agent flow rate to 0.6 mg/L is highly effective at reducing all hexavalent chromium to trivalent chromium. The data also demonstrate that the system was highly effective at removing total chromium from the water. The data also demonstrate that water treated using the system of modified system of Example 1 and the modified method of Example 2 produced water that meets and exceeds an MCL of 10 ppb for hexavalent chromium, as set by the state of California.

TABLE 3

| | Cumulative | Raw Water | | Treated Water | |
|---|---|---|---|---|---|
| | Water | Cr (total) | Cr (6+) | Cr (total) | Cr (6+) |
| Sample Day | Treated (gal) | μg/L | μg/L | μg/L | μg/L |
| 1 | 0 | 12 | 13 | ND | ND |
| 2 | 1,062 | 12 | 13 | ND | ND |
| 3 | 4,358 | 12 | 12 | ND | ND |
| 4 | 12,388 | 13 | 14 | ND | ND |
| 5 | 13,095 | 14 | 12 | ND | ND |
| 6 | 23,530 | 12 | 12 | ND | 1.1 |
| 7 | 39,589 | 11 | 13 | ND | 1.1 |
| 8 | 50,917 | 12 | 12 | ND | ND |
| 9 | 51,793 | 11 | 12 | ND | ND |

Water samples were analyzed for total iron levels according to the method of Example 4. Data are presented in Table 4. Total iron levels were non-detectable in all but one sample. The data suggest that the filtration unit fully filtered the iron particles and allowed little or no passage of filterable solids.

All detectable iron was in the fully oxidized ferric oxide form, suggesting that the ferrous sulfate reducing agent solution was fully oxidized during the reduction of hexavalent chromium to trivalent chromium.

TABLE 4

| | Total Iron (μg/L Fe) |
|---|---|
| Sample Date | Treated Water Post Media Filter |
| 1 | ND |
| 2 | ND |
| 3 | ND |
| 4 | 120 |
| 5 | ND |
| 6 | ND |
| 7 | ND |
| 8 | ND |
| 9 | ND |

The collected backwash particulate was analyzed by two methods. A solids wet cake sample was submitted to a third-party laboratory for California STLC Leachate CA WET evaluation of leachate metals. Another sample was dewatered and sent to the laboratory for TCLP Toxic Characteristic Leaching Procedure testing.

The data are presented in Table 5. The data demonstrate that the waste materials meet and exceed the standard RCRA TCLP test and are deemed non-hazardous solid waste. In California, the waste may be considered hazardous waste.

TABLE 5
Waste Characterization Study Test Results

| | STLC Leachate CA WET | TCLP |
|---|---|---|
| Arsenic, mg/L | 0.94 | <0.025 |
| Barium, mg/L | <5.0 | 1.5 |
| Cadmium, mg/L | <0.050 | <0.010 |
| Chromium, mg/L | 36.9 | <0.010 |
| Lead, mg/L | <0.25 | <0.050 |
| Mercury, mg/L | <0.0050 | <0.00010 |
| Selenium, mg/L | <0.25 | <0.050 |
| Silver, mg/L | <0.13 | <0.030 |

To further characterize the materials collected, a dried filter cake sample was quantitatively tested for RCRA metal content. The results demonstrate that 3,910 mg/kg of sample (ppm) or 0.39 percent of the sample consists of chrome metal waste. Analysis of the filtration unit showed that most of the collected solids were deposited over the first 2-4 inches of the graded sand section of the unit. Overall, the modified system and method produce low volumes of waste that are easy and inexpensive to dispose of.

### Example 7: Additional Pilot Test

A 1.20 gpm pilot test system was installed at a groundwater well in California. The hexavalent chrome concentration of water produced from this well tests consistently between 19 to 22 μg/L. The pilot test equipment was placed into service for use in treating a small bleed stream from the main well water supply. An automated control system accommodated interruptions in flow from the well water source.

The pilot-scale treatment system comprised the system 100 as described herein. As described in FIG. 1, the system includes a prefilter, a reducing agent injection system to meter reducing agent upstream of a an in-line mixer, a 4-inch diameter by 40-inch vertical height contactor column, containing 24 inches (4,500 grams) of contactor media, such as a transition metal loaded zeolite contactor media, and a downflow 6-inch diameter by 48-inch vertical height multimedia filter unit containing approximately 24-inches of inert filter media. The contactor media may also be referred to as reactor media. The zeolite used in this example was clinoptilolite. A final cartridge filter unit was used to assess the effectiveness of the media filter system. The source water enters the pilot test unit from a connection on the main well discharge piping through a flexible hose and a pressure reducing valve and a flow meter totalizer. The process was upflow through the media contactor, with the flow exiting the top of the column, then directed through flexible tubing to the downflow filter media column. During the service cycle the test samples were collected at the prior to the chemical addition and at the treated water discharge point.

The media filter column was backwashed once per 24 hr. operating period with the treatment system operating 24-hours continuously per day. Backwashing was accomplished by directing raw water upflow through the media column to expand the media bed and release the collected solids to exit the column out of the top of the column. The backwashed liquid and solids were collected separately for testing to determine solids settling rate, and to characterize the collected solids.

While the method of Example 2 was being performed, water samples were collected in the system 100 upstream of the addition of the reducing agent solution 124 (“raw water” samples) and at the treated water outlet 120 (“treated water” samples). Samples were analyzed using EPA Method 200.7 for determining levels of total chromium (Cr(III)+Cr(VI)) in water and EPA Method 218.6 for determining levels of hexavalent chromium in water.

Data are presented in Table 6. Levels of both hexavalent chromium and total chromium were non-detectable (“ND”) in almost all samples when the system was fully operational. The presence of chromium in the treated samples when the reducing agent was not added (see Sample Date of Month Two, Days 2, 4, 7 and 24) suggests that the reducing agent solution plays a role in the effective reduction of hexavalent chromium to trivalent chromium and the removal of total chromium from the water.

The data demonstrate that the system of Example 1 and the method of Example 2 were highly effective at reducing all hexavalent chromium to trivalent chromium. The data also demonstrate that the system was highly effective at removing total chromium from the water.

TABLE 6

| | Raw Water | | Treated Water | | | Post Filter | |
|---|---|---|---|---|---|---|---|
| | Hexavalent | Total Chrome | Hexavalent | Total Chrome | | Hexavalent | Total Chrome |
| Sample Date | Chrome (Cr⁶⁺ | (Total Cr μg/L) | Chrome (Cr⁶⁺ | (Total Cr μg/L) | Iron (Fe μg/L) | Chrome (Cr⁶⁺ | (Total Cr μg/L) |
| Month 1, Day 14 | 21 | 21 | ND | 3.7 | | ND | 14 |
| Month 1 Day 17 | 20 | 22 | ND | 6.6 | | ND | 7.2 |
| Month 1 Day 19 | 19 | 19 | ND | 2.3 | | | |
| Month 1 Day 21 | 19 | 19 | ND | 4.0 | | ND | 4.8 |
| Month 1 Day 24 | 20 | 20 | ND | 6.8 | | | |
| Month 1 Day 26 | 20 | 21 | ND | 6.0 | | | |
| Month 1 Day 31 | 19 | 19 | ND | 6.1 | | | |
| Month 2 Day 2 | 19 | 19 | 14 | 15.0 | ND | | |
| Month 2 Day 4 | 19 | 19 | 13 | 14.0 | ND | | |
| Month 2 Day 7 | 18 | 18 | 14 | 18.0 | 130 | | |
| Month 2 Day 24 | | | 1.1 | 4.8 | 130 | | |
| Month 2 Day 28 | 19 | 19 | ND | ND | ND | ND | 1.3 |
| Month 2 Day 29 | 18 | 19 | ND | ND | ND | | |
| Month 2 Day 30 | 19 | 19 | ND | 2.3 | 130 | | |
| Month 2 Day 31 | 20 | 20 | ND | 2.5 | 110 | | |
| Month 3 Day 1 | 17 | 19 | ND | ND | ND | | |
| Month 3 Day 6 | 19 | 19 | ND | ND | ND | | |
| Month 3 Day 8 | 19 | 20 | ND | 1.8 | ND | | |
| Month 3 Day 11 | 19 | 19 | ND | 1.4 | ND | | |
| Month 3 Day 13 | 19 | 19 | ND | ND | ND | | |
| Month 3 Day 15 | 18 | 20 | ND | 4.1 | 190 | | |
| Month 3 Day 18 | 18 | 21 | ND | 2.8 | 120 | | |
| Month 3 Day 20 | 18 | 18 | ND | 1.6 | ND | | |
| Month 3 Day 26 | 19 | 19 | ND | 2.1 | 110 | | |
| Month 3 Day 29 | 20 | 22 | ND | 2.1 | ND | | |
| Month 4 Day 5 | 19 | 21 | ND | ND | ND | | |
| Month 4 Day 10 | 19 | 19 | 7.3 | ND | 410 | | |
| Month 4 Day 11 | 18 | 19 | ND | 3.1 | 150 | | |
| Month 4 Day 18 | 18 | 19 | ND | 1.5 | ND | | |
| Month 4 Day 19 | 18 | 20 | ND | 1.4 | ND | | |
| Month 4 Day 20 | 19 | 22 | ND | 2.4 | 100 | | |
| Month 4 Day 23 | 20 | 21 | ND | 1.6 | ND | | |
| Month 4 Day 25 | 18 | 18 | ND | 1.6 | ND | | |
| Month 4 Day 27 | 19 | 20 | ND | 1.2 | ND | | |
| Month 4 Day 31 | 20 | 20 | ND | 1.7 | ND | | |

The foregoing description and drawings illustrate certain principles of particular embodiments but are not intended to limit the scope of the invention. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of, and are thus within the spirit and scope of, the present invention.

What is claimed is:

1. A system for removing chromium from an aqueous medium comprising:
a reducing agent;
a reactor media comprising a zeolite; and
a solids filtration unit.

2. The system of claim 1, wherein the reducing agent is a transitional metal based reducing agent.

3. The system of claim 1, wherein the reducing agent is ferrous sulfate.

4. The system of claim 1, wherein the zeolite is clinoptilolite

5. The system of claim 1, wherein the zeolite is a transition metal-loaded zeolite.

6. The system of claim 5, wherein the transition metal is iron.

7. The system of claim 1, wherein the solids filtration unit includes graded sand.

8. The system of claim 1, wherein the reactor media is provided in a column.

9. The system of claim 1, wherein the solids filtration unit is selected from a horizontal cylinder and a vertical column.

10. The system of claim 1, wherein the aqueous medium is water from drinking water source.

11. A method of removing chromium from an aqueous medium comprising:
providing a raw aqueous medium and a reducing agent;
contacting the raw aqueous medium with a reactor media;
reducing hexavalent chromium in the aqueous medium;
oxidizing the reducing agent;
capturing the reduced chromium and the oxidized reducing agent; and
releasing a treated aqueous medium having a reduced level of chromium.

12. The method of claim 11, wherein the reduced chromium is trivalent chromium.

13. The method of claim 11, wherein the reducing and oxidizing occur in or on the reactor media.

14. The method of claim 11, wherein the reduced chromium and the oxidized reducing agent are insoluble and co-precipitate.

15. The method of claim 14, wherein the reduced chromium and the oxidized reducing agent pass through the reactor media.

16. The method of claim 14, comprising adsorbing the reduced chromium on the oxidized reducing agent.

17. The method of claim 11, wherein the reduced level of chromium is 100 ppb or less of total chromium.

18. The method of claim 11, wherein the reduced level of chromium is 10 ppb or less of hexavalent chromium.

19. The method of claim 11, comprising releasing and collecting the captured reduced chromium and oxidized reducing agent.

20. The method of claim 19, wherein the releasing is by backwashing.
